(19) United States
(12) Patent Application Publication
(10) Pub. No.: US 2008/0219667 A1
(43) Pub. Date: Sep. 11, 2008

(54) OPTICAL COMMUNICATION SYSTEM AND DISPERSION-COMPENSATING OPTICAL FIBER

(75) Inventor: Katsunori IMAMURA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: The Furukawa Electric Co, Ltd., Tokyo (JP)

(21) Appl. No.: 12/108,215

(22) Filed: Apr. 23, 2008

Related U.S. Application Data
(63) Continuation of application No. PCT/JP07/70163, filed on Oct. 16, 2007.

(30) Foreign Application Priority Data
Oct. 16, 2006 (JP) 2006-281972

(51) Int. Cl. H04J 14/02; G02B 6/34

(52) U.S. Cl. 398/81; 385/37

(57) ABSTRACT

With this scheme, there is provided an optical communication system and a dispersion-compensating optical fiber with which a long-haul optical signal transmission is possible by making use of the low optical nonlinearity and the low transmission loss characteristic of the photonic bandgap optical fiber.

### CROSS-REFERENCE TO RELATED APPLICATIONS

This application is a continuation of PCT international application Ser. No. PCT/JP2007/070163 filed Oct. 16, 2007 which designates the United States, incorporated herein by reference, and which claims the benefit of priority from Japanese Patent Application No. 2006-281972, filed Oct. 16, 2006, incorporated herein by reference.

### BACKGROUND OF THE INVENTION

1. Field of the Invention

The present invention relates to an optical communication system employing an optical fiber as an optical transmission path and a dispersion-compensating optical fiber.

2. Description of the Related Art

A usage of a photonic bandgap optical fiber (Photonic BandGap Fiber, PBGF) is getting a high attention for a non-communication application that is represented by a transmission of a high-power light. In the photonic bandgap optical fiber, a Bragg grating is formed by periodically arranging a medium having a refractive index different from a refractive index of the cladding layer, such as air, in the cladding, and a light having a predetermined operation wavelength within a photonic bandgap that is formed by the Bragg grating propagates through a hollow that is provided in the cladding as a core. As for the photonic bandgap optical fiber, a commercial-based introduction has been published as shown in CRYSTAL FIBRE A/S, “AIRGUIDING HOLLOW-CORE PHOTONIC BANDGAP FIBERS SELECTED DATASHEETS HC-1550-02, HC19-1550-01”, [online], [Searched on Sep. 6, 2006], Internet (URL: http://www.crystal-fibre.com/products/airguide.shtm) (hereinafter, referred to as “Literature 1”).

On the other hand, regarding a hole-based optical fiber (Microstructure Optical Fiber, MOF) that does not employ the photonic bandgap phenomenon, such as a holey fiber or a photonic crystal optical fiber (Photonic Crystal Fiber, PCF), a possibility of using them for a communication application is massively reviewed because of its broadband transmission potential and the like. For example, in K. Kurokawa, et al., “Penalty-Free Dispersion-Managed Soliton Transmission over 100 km Low Loss PCF”, Proc. OFC PDP21 (2005) (hereinafter, referred to as “Literature 2”), transmission characteristics of a dispersion-managed soliton with a transmission speed of 10 Gb/s have been reported using an optical transmission line over 100 km by combining the PCF and a dispersion compensating fiber (Dispersion Compensating Fiber, DCF).

However, even for the photonic bandgap optical fiber, it has a great attraction because of its low optical nonlinearity and low transmission loss potential.

Nevertheless, as shown in Literature 1, the photonic bandgap optical fiber has considerably large wavelength dispersion at an operation wavelength that is a wavelength of an optical signal used in the communication. Because this larger wavelength dispersion affects the optical signal, causing a distortion of a signal waveform and the like, there has been a problem that a long-haul optical signal transmission using the photonic bandgap optical fiber is difficult.

The present invention has been achieved in consideration of the above-described aspect, and it is an object of the present invention to provide an optical communication system and a dispersion-compensating optical fiber with which a long-haul optical signal transmission is possible by making use of the low optical nonlinearity and the low transmission loss characteristic of the photonic bandgap optical fiber.

### SUMMARY OF THE INVENTION

It is an object of the present invention to at least partially solve the problems in the conventional technology.

According to an aspect of the present invention, an optical communication system includes an optical fiber as an optical transmission line. The optical transmission line includes a photonic bandgap optical fiber that includes a core that is formed with a hole at a center, a second cladding that is formed on an outer side of the core, and a first cladding that is formed between the core and the second cladding, in which a Bragg grating is formed by periodically arranging a medium having a refractive index that is different from a refractive index of the second cladding, and that propagates a light having a predetermined operation wavelength within a photonic bandgap that is formed by the Bragg grating; and a dispersion compensator that is connected closely to the photonic bandgap optical fiber and that has a negative wavelength dispersion for compensating for a wavelength dispersion of the photonic bandgap optical fiber at the operation wavelength.

According to another aspect of the present invention, a dispersion-compensating optical fiber is configured to be connected closely to a photonic bandgap optical fiber. The photonic bandgap optical fiber includes a core that is formed with a hole at a center, a second cladding that is formed on an outer side of the core, and a first cladding that is formed between the core and the second cladding, in which a Bragg grating is formed by periodically arranging a medium having a refractive index that is different from a refractive index of the second cladding, and that propagates a light having a predetermined operation wavelength within a photonic bandgap that is formed by the Bragg grating. The dispersion-compensating optical fiber has a negative wavelength dispersion for compensating for a wavelength dispersion of the photonic bandgap optical fiber at the operation wavelength.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an optical communication system according to an embodiment of the present invention;

FIG. 2 is a schematic cross section of a PBGF included in an optical transmission line of the optical communication system shown in FIG. 1;

FIG. 3 is a schematic cross section of a dispersion compensator included in an optical transmission line of the optical communication system shown in FIG. 1;

FIG. 4 is a schematic diagram illustrating a cross section of a DCF according to the embodiment of the present invention and a corresponding refractive index profile;

FIG. 5 is a graph showing a relationship between the wavelength dispersion of the DCF and the total transmission loss of the DCF of a required length for compensating for the wavelength dispersion of the PBGF in the cases of a 50-km-long and a 100-km-long PBGFs;

FIG. 6 is a graph showing a calculation result by a simulation of an optimization design for Δ2 and Δ3;

FIG. 7 is a graph showing a calculation result by a simulation of an optimization design for Δ2 and Δ3;

FIG. 8 is a table of design parameters and calculated optical characteristics of the DCF according to the embodiment of the present invention;

FIG. 9 is a table of design parameters and optical characteristics of a fabricated DCF; and

FIG. 10 is a block diagram for schematically illustrating a configuration of a fiber-Bragg-grating-type dispersion compensator according to a modification example of the embodiment of the present invention.

### DETAILED DESCRIPTION OF THE PREFERRED EMBODIMENTS

Exemplary embodiments of an optical communication system and a dispersion-compensating optical fiber according to the present invention will be explained in detail below with reference to the accompanying drawings. However, the present invention is not to be considered limited to the embodiments. Hereinafter, a photonic bandgap optical fiber is referred to as a PBGF and a dispersion compensating fiber is referred to as a DCF. The cutoff wavelength (λ_{c}) referred in this specification means the fiber cutoff wavelength defined in the ITU-T (International Telecommunication Union Telecommunication Standardization Sector) G. 650. 1. Other terminologies not specifically defined in this specification comply with the definitions and the measurement methods in the ITU-T G. 650. 1.

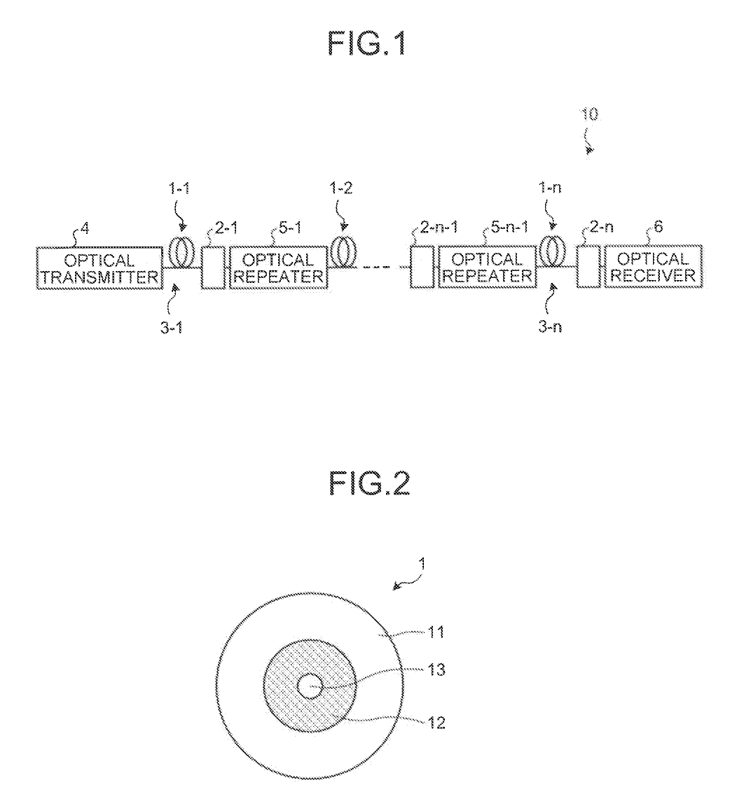

FIG. 1 is a block diagram of an optical communication system according to an embodiment of the present invention. As shown in FIG. 1, an optical communication system 10 according to the present embodiment includes an optical transmitter 4 that transmits an optical signal, optical repeaters 5-1 to 5-n-1 that regenerates and relays the optical signal transmitted from the optical transmitter 4, an optical receiver 6 that receives the optical signal regenerated and relayed by the optical repeaters 5-1 to 5-n-1, and optical transmission lines 3-1 to 3-n-1 that connects the optical transmitter 4, the optical repeaters 5-1 to 5-n-1, and the optical receiver 6, to transmit the optical signal, where n is an integer equal to or larger than two.

The optical transmission lines 3-1 to 3-n-1 includes PBGFs 1-1 to 1-n and dispersion compensators 2-1 to 2-n connected closely to the PBGFs 1-1 to 1-n. Portions of the optical transmission line 3 other than the PBGFs 1-1 to 1-n and the dispersion compensators 2-1 to 2-n are formed with a standard single-mode optical fiber. FIG. 2 is a schematic cross section of the PBGF included in the optical transmission line of the optical communication system shown in FIG. 1. The PBGF 1 is the same as the one shown in Literature 1, including a second cladding region 11 and a first cladding region 12 in which a Bragg grating is formed by periodically arranging micro-holes of a medium that has a refractive index different from a refractive index of the second cladding region 11. A core 13 is formed by a hollow hole near the center of the PBGF, through which a light having an operation wavelength within the photonic bandgap formed by the Bragg grating propagates. The operation wavelength is 1550 nm that is the center wavelength of the photonic bandgap formed by the Bragg grating. The PBGF 1 has a large wavelength dispersion equal to or larger than 50 ps/nm/km at the operation wavelength of 1550 nm and a large dispersion slope equal to or larger than 0.5 ps/nm²/km.

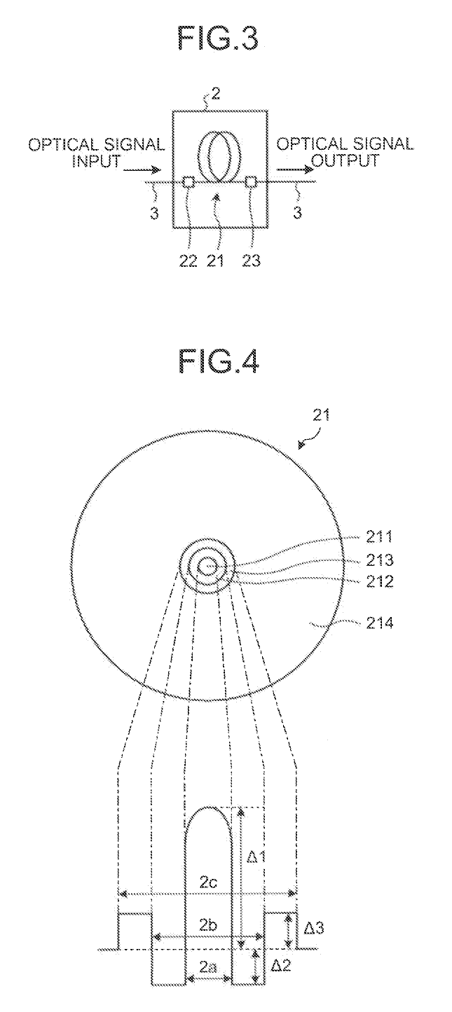

FIG. 3 is a schematic cross section of the dispersion compensator included in the optical transmission line of the optical communication system shown in FIG. 1. The dispersion compensator 2 is a fiber-type dispersion compensator, including a DCF 21 and connecting portions 22 and 23. The DCF 21 is connected to the optical transmission line 3 via the connecting portions 22 and 23.

Because the DCF 21 according to the present embodiment has a negative wavelength dispersion for compensating for the wavelength dispersion of the PBGF 1 at the operation wavelength of 1550 nm, it is possible to suppress a negative influence of the extremely large wavelength dispersion of the PBGF 1 on a propagating optical signal, such as a distortion of the optical signal. As a result, the optical communication system 10 is capable of achieving a long-haul optical signal transmission making use of the low optical nonlinearity and the low transmission loss characteristic of the PBGF 1.

In addition, because the DCF 21 has a negative dispersion slope for compensating for a dispersion slope of the PBGF 1, it is possible to compensate for the extremely larger wavelength dispersion of the PBGF 1 not only at the operation wavelength but also in a broad wavelength band including the operation wavelength. As a result, the optical communication system 10 is capable of achieving a long-haul optical signal transmission making use of the low optical nonlinearity and the low transmission loss characteristic over a broad bandwidth, and is suitable for a large-capacity optical signal transmission such as a wavelength division multiplexing (WDM) transmission.

Furthermore, because the DCF 21 has a wavelength dispersion of an absolute value equal to or larger than three times of the wavelength dispersion of the PBGF 1 at the operation wavelength of 1550 nm, a total transmission loss can be suppressed within a desired range. Moreover, because the DCF has a value equal to or smaller than 100 nm as a value obtained by dividing the wavelength dispersion by the dispersion slope at the operation wavelength of 1550 nm, it is possible to compensate for the wavelength dispersion over a broader bandwidth even for the PBGF 1 of which both the wavelength dispersion and the dispersion slope are large. A detailed explanation will be given below.

For example, in Literature 1, a PBGF having a wavelength dispersion of 97 ps/nm/km and a dispersion slope of 0.5 ps/nm²/km at an operation wavelength of 1550 nm (hereinafter, this PBGF is referred to as a PBGF-A) and a PBGF having a wavelength dispersion of 50 ps/nm/km and a dispersion slope of 1.5 ps/nm²/km at an operation wavelength of 1570 nm (hereinafter, this PBGF is referred to as a PBGF-B) are described. Because both of the PBGFs have a larger wavelength dispersion equal to or larger than 50 ps/nm/km, if the wavelength dispersion of the DCF is small, a length of the DCF required for compensating for the wavelength dispersion of the PBGF becomes long, and the total transmission loss of the DCF becomes extremely large.

FIG. 5 is a graph showing a relationship between the wavelength dispersion of the DCF and the total transmission loss of the DCF of a required length for compensating for the wavelength dispersion of the PBGF-B in the cases of a 50-km-long and a 100-km-long PBGF-Bs. As for the transmission loss of the DCF, a typical value of 0.7 dB/km is assumed. As shown in FIG. 5, because the required length of the DCF becomes large if the wavelength of the DCF is small, the total transmission loss of the DCF is abruptly increased. Although the total transmission loss of the DCF can be compensated by using an erbium-doped optical fiber amplifier (EDFA), it is preferable that the total transmission loss of the DCF should be equal to or smaller than 20 dB, considering the amplification characteristics of the EDFA. Therefore, when compensating for the wavelength dispersion of the 100-km-long PBGF-B by increasing the transmission span between optical repeaters, if an absolute value of the wavelength dispersion of the DCF at the operation wavelength is equal to or larger than three times of the wavelength dispersion of the PBGF, or more preferably equal to or larger than four times of the wavelength dispersion of the PBGF, it is possible to suppress the total transmission loss of the DCF to a value that can be easily compensated by the EDFA, which is desirable. For example, when the PBGF-B is used as the PBGF, it is preferable that the wavelength dispersion of the DCF 21 at the operation wavelength should be equal to or smaller than −150 ps/nm/km, and is particularly preferable that it should be equal to or small than −200 ps/nm/km. On the other hand, when the PBGF-A is used as the PBGF, it is preferable that the wavelength dispersion of the DCF at the operation wavelength should be equal to or smaller than −300 ps/nm/km, and is particularly preferable that it should be equal to or small than −400 ps/nm/km.

It is important to consider a dispersion compensation ratio as an index indicating a bandwidth over which the DCF can compensate for the wavelength dispersion for an application such as the WDM transmission. The dispersion compensation ratio is obtained by Equation (1) when the PBGF is used as the optical transmission line.

dispersion compensation ratio=DPS of PBGF/DPS of DCF×100=(wavelength dispersion of PBGF/dispersion slope of PBGF)/(wavelength dispersion of DCF/dispersion slope of DCF) (1)

where DPS (Dispersion Per Slope) means a value obtained by dividing the wavelength dispersion by the dispersion slope.

As the dispersion compensation ratio approaches 100%, the dispersion of the PBGF is compensated by the DCF in a broader bandwidth, which is desirable. As indicated by Equation (1), for the dispersion compensation ratio to approach 100%, it is necessary to use a DCF having a DPS close to the DPS of the PBGF.

In this case, the DPS of the PBGF-A is as large as 200 nm, the dispersion compensation ratio can be increased up to certain level even with a conventional DCF. On the other hand, the DPS of the PBGF-B is as small as 33 nm, it is difficult to increase the dispersion compensation ratio with the conventional DCF.

However, if the DPS of the DCF is equal to or smaller than 100 nm, because the dispersion compensation ratio can be as large as 30%, which is large enough, even for a PBGF having a small DPS, such as the PBGF-B, it is possible to compensate for the dispersion over a broad bandwidth.

Next, the DCF 21 according to the present embodiment will be explained in more detail. FIG. 4 is a schematic diagram illustrating a cross section of the DCF according to the present embodiment and a corresponding refractive index profile.

The DCF 21 includes a center core region 211, an inner core layer 212 that is formed around the center core region 211 and that has a refractive index lower than a refractive index of the center core region 211, an outer core layer 213 that is formed around the inner core layer 212 and that has a refractive index lower the refractive index of the center core region 211 and higher than the refractive index of the inner core layer 212, and a cladding layer 214 that is formed around the outer core layer 213 and that has a refractive index higher than the refractive index of the inner core layer 212 and lower than the refractive index of the outer core layer 213. A relative refractive index difference Al of the center core region 211 with respect to the cladding layer 214 is in a range between 1.6% and 3.0%, inclusive, a relative refractive index difference Δ2 of the inner core layer 212 with respect to the cladding layer 214 is in a range between −1.6% and −0.2%, inclusive, a relative refractive index difference Δ3 of the outer core layer 213 with respect to the cladding layer 214 is in a range between 0.1% and 0.7%, inclusive, a ratio a/c of a diameter 2a of the center core region 211 to an outer diameter 2c of the outer core layer 213 is in a range between 0.05 and 0.4, inclusive, a ratio b/c of an outer diameter 2b of the inner core layer 212 to the outer diameter 2c of the outer core layer 213 is in a range between 0.4 and 0.85, inclusive, and an outer radius c of the outer core layer 213 is in a range between 5 μm and 25 μm, inclusive.

In addition, more preferably, the relative refractive index difference Δ1 of the center core region 211 with respect to the cladding layer 214 should be in a range between 1.9% and 2.7%, inclusive, an α value that defines a profile of the center core region 211 should be in a range between 2 and 20, inclusive, the relative refractive index difference Δ2 of the inner core layer 212 with respect to the cladding layer 214 should be in a range between −1.62% and −0.6%, inclusive, the relative refractive index difference Δ3 of the outer core layer 213 with respect to the cladding layer 214 should be in a range between 0.2% and 0.6%, inclusive, the ratio a/c of the diameter 2a of the center core region 211 to the outer diameter 2c of the outer core layer 213 should be in a range between 0.1 and 0.3, inclusive, the ratio b/c of the outer diameter 2b of the inner core layer 212 to the outer diameter 2c of the outer core layer 213 should be in a range between 0.5 and 0.75, inclusive, and the outer radius c of the outer core layer 213 should be in a range between 10 μm and 20 μm, inclusive.

With the above configuration, the DCF 21 has the wavelength dispersion of −150 ps/nm/km, the DPS equal to or smaller than 100 nm, the cutoff wavelength of 1550 nm, and a bending loss equal to or smaller than 10 dB/m under a condition of 20φ×16 turns.

A processing procedure of a design optimization for realizing desired optical characteristics for the refractive index profile shown in FIG. 4 will be explained in detail below. Seven refractive index parameters Δ1, Δ2, Δ3, α value, a/c, b/c, and c are used in the optimization.

The α value is a parameter that defines the profile of the center core region, and when the α value is set to α, α is defined by Equation (2).

n²(r)=n_{core}²×{1-2×(Δ/100)×(r/a)̂α} (where 0<r<a) (2)

Here, r is a point from the center of the center core region in the radial direction, n(r) is the refractive index at the point r, and a is the radius of the center core region. “̂” is a symbol representing an exponential.

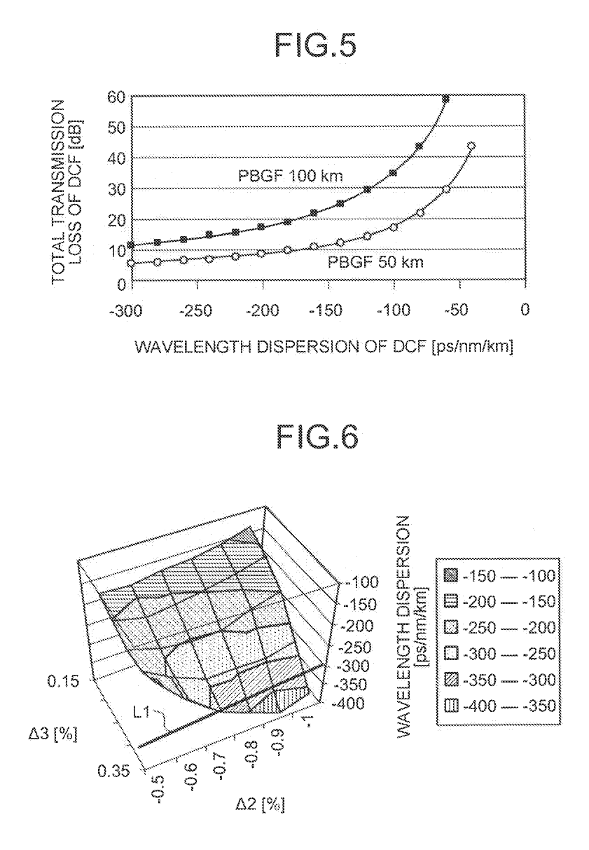

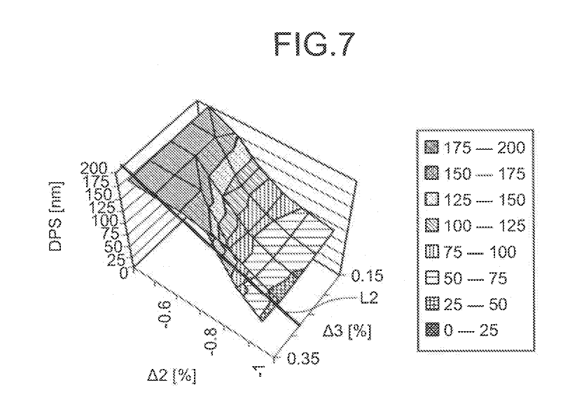

When the bending loss of the DCF is increased, it becomes difficult to use the DCF in the form of a module or a cable. For this reason, the design optimization is performed by selecting the core diameter as 2c with which the bending loss under the condition of 20φ×16 turns becomes equal to or smaller than 10 dB/m that is the same level as the bending loss of the conventional DCF. An example of the design optimization for Δ2 and Δ3 is described below. First, rough ranges of the seven parameters are determined by an approximate calculation, and after that, Δ2 and Δ3 are optimized by fixing Δ1 to 2.5%, the α value to 3, a/c to 0.2, b/c to 0.6, and 2c to a value with which β/k becomes 1.4460. FIGS. 6 and 7 are graphs showing calculation results by the simulation when the design optimization is performed for Δ2 and Δ3. FIG. 6 shows a relationship between Δ2, Δ3 and the wavelength dispersion, and FIG. 7 shows a relationship between Δ2, Δ3, and the DPS. Lines L1 and L2 indicates a boundary line at which the cutoff wavelength becomes 1550 nm. A side on which Δ3 is smaller than the lines L1 and L2 is an area in which the cutoff wavelength is equal to or shorter than 1550 nm.

When Δ2 is decreased, the DPS can be decreased as shown in FIG. 7; however, the wavelength dispersion is increased after a short decrease as shown in FIG. 7. On the other hand, if Δ3 is increased, the wavelength dispersion is decreased as shown in FIG. 6; however, the DPS increases after a short decrease and the cutoff wavelength exceeds 1550 nm as shown in FIG. 7. Considering this tradeoff relationship, it is confirmed that there are optimized solutions of Δ2 in a range between −1.00% and −0.70%, inclusive and Δ3 in a range between 0.17% and 0.30%, inclusive. As a result of investigating a solution existing range from the same calculation by changing Δ1, the α value, a/c, b/c and the like, it is confirmed that the solution exists when Δ1 is in a range between 1.6% and 3.0%, inclusive, Δ2 is in a range between −1.6% and −0.2%, inclusive, Δ3 is in a range between 0.1% and 0.7%, a/c is in a range between 0.05 and 0.4, inclusive, b/c is in a range between 0.4 and 0.85, inclusive, and c is in a range between 5 μm and 25 μm, inclusive.

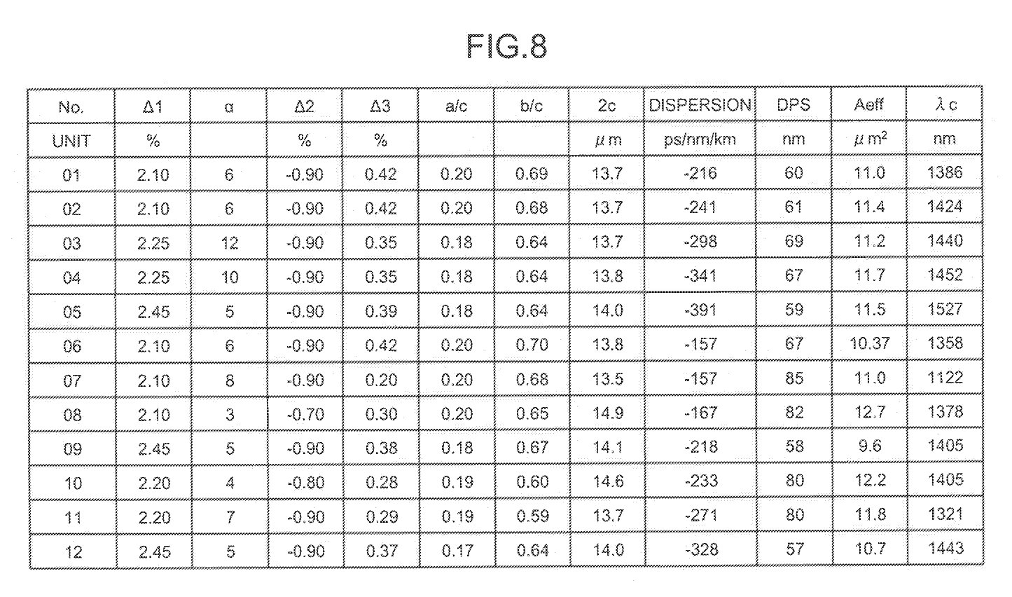

Subsequently, a detailed example of the calculation result will be presented. FIG. 8 is a table of the design parameters and calculated optical characteristics of the DCF 21 according to the present embodiment. The dispersion means the wavelength dispersion, Aeff means the effective core size. All of dispersion, Aeff, and DPS indicate values at the wavelength of 1550 nm. For example, the DCFs from the number 01 to the number 05 are designed with target values of −200 ps/nm/km, −250 ps/nm/km, −300 ps/nm/km, −350 ps/nm/km, and −400 ps/nm/km, respectively. As shown in FIG. 8, all the DCFs from the number 01 to the number 12 have negative wavelength dispersions with extremely larger absolute values, equal to or smaller than −150 ps/nm/km, and extremely small DPSs equal to or smaller than 100 nm, and therefore, it is possible to compensate for the wavelength dispersion of a PBGF of a long branch length with a short branch length while suppressing the total transmission loss, and to compensate for the dispersion over a broad bandwidth. Furthermore, the bending loss can be suppressed below 10 dB/m under a condition of 20φ×16 turns. As a result, the DCF can be used in the form of a module or a cable. In addition, because Δ1 is the same level of magnitude as that of the conventional DCF while realizing the wavelength dispersion and the DPS, it is considered that the manufacturability is good as well as the transmission loss characteristic.

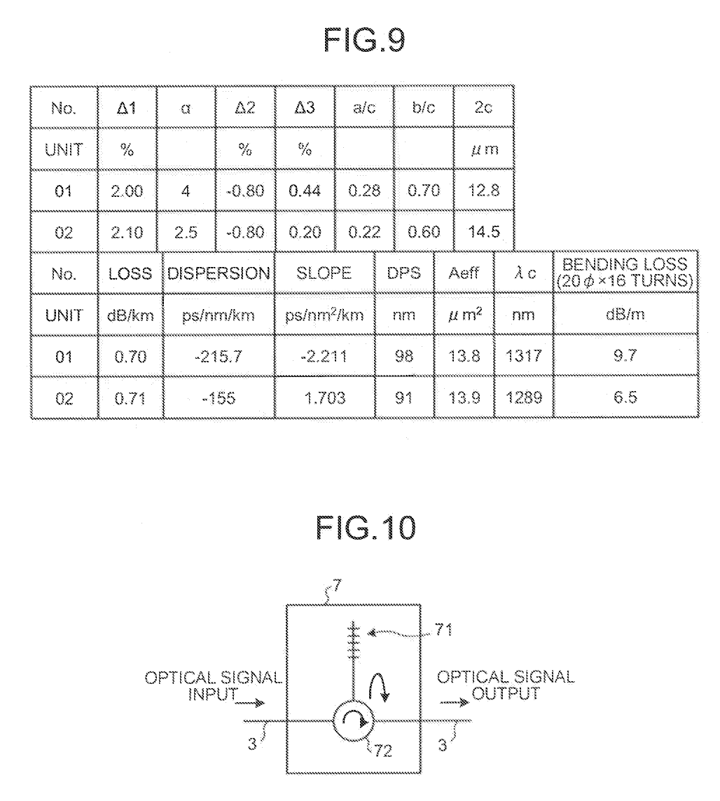

Next, an example of an actual fabrication of the DCF according to the present embodiment will be explained. FIG. 9 is a table of the design parameters and optical characteristics of the fabricated DCF. The upper part shows the design parameters and the lower part shows the optical characteristics. The Loss means the transmission loss at the wavelength of 1550 nm, and the slope means a dispersion slope at the wavelength of 1550 nm. As shown in FIG. 9, the actually fabricated DCF shows the same level of optical characteristics as the calculation result shown in FIG. 8 in all the cases including the numbers 01 and 02.

Although the fiber-type dispersion compensator is employed in the optical communication system according to the present embodiment, a fiber-Bragg-grating-type dispersion compensator can also be used as a modification example of the present embodiment. FIG. 10 is a block diagram for schematically illustrating a configuration of a fiber-Bragg-grating-type dispersion compensator according to a modification example of the embodiment of the present invention. The fiber-Bragg-grating-type dispersion compensator 7 includes a dispersion-compensating fiber Bragg grating 71 and an optical circulator 72. The input and output ports of the optical circulator 72 are connected to optical transmission lines 3 and 3 and the dispersion-compensating fiber Bragg grating 71. The optical circulator 72 receives an optical signal having an operation wavelength at which a waveform distortion is given by a PBGF from the optical transmission line 3 on the left side of the figure, and outputs the optical signal to the dispersion-compensating fiber Bragg grating 71. Then, the dispersion-compensating fiber Bragg grating 71 resolves the waveform distortion of the input optical signal by reflecting the optical signal in a distributed manner by a grating that is formed in a core region, and outputs the optical signal to the optical circulator 72. The optical circulator 72 outputs the optical signal of which the waveform distortion is resolved to the optical transmission line 3 on the right side of the figure. As a result, the fiber-Bragg-grating-type dispersion compensator 7 compensates for the wavelength dispersion of the PBGF at the operation wavelength and makes it possible to perform a long-haul optical signal transmission making use of the low optical nonlinearity and the low transmission loss characteristic of the PBGF.

In the optical communication system according to the embodiment, because the optical transmission line includes a photonic bandgap optical fiber and a dispersion compensator that has a negative wavelength dispersion for compensating for the wavelength dispersion of the photonic bandgap optical fiber at the operation wavelength, it is possible to suppress a negative influence of the extremely large wavelength dispersion of the photonic bandgap optical fiber on a propagating optical signal, such as a distortion of the optical signal. Therefore, there is an effect that a long-haul optical signal transmission making use of the low optical nonlinearity and the low transmission loss characteristic of the photonic bandgap optical fiber can be achieved.

Furthermore, the dispersion-compensating optical fiber according to the embodiment is connected closely to a photonic bandgap optical fiber and has a negative wavelength dispersion for compensating for a wavelength dispersion of the photonic bandgap optical fiber at the operation wavelength. Therefore, because it is possible to suppress a negative influence of the extremely large wavelength dispersion of the photonic bandgap optical fiber on a propagating optical signal, such as a distortion of the optical signal, there is an effect that a long-haul optical signal transmission making use of the low optical nonlinearity and the low transmission loss characteristic can be achieved by combining the dispersion-compensating optical fiber with the photonic bandgap optical fiber.

Further effect and modifications can be readily derived by persons skilled in the art. Therefore, a more extensive mode of the present invention is not limited by the specific details and the representative embodiment. Accordingly, various changes are possible without departing from the spirit or the scope of the general concept of the present invention defined by the attached claims and the equivalent.

What is claimed is:

1. An optical communication system comprising an optical fiber as an optical transmission line, wherein the optical transmission line includes
a photonic bandgap optical fiber that includes a core that is formed with a hole at a center, a second cladding that is formed on an outer side of the core, and a first cladding that is formed between the core and the second cladding, in which a Bragg grating is formed by periodically arranging a medium having a refractive index that is different from a refractive index of the second cladding, and that propagates a light having a predetermined operation wavelength within a photonic bandgap that is formed by the Bragg grating, and
a dispersion compensator that is connected closely to the photonic bandgap optical fiber and that has a negative wavelength dispersion for compensating for a wavelength dispersion of the photonic bandgap optical fiber at the operation wavelength.

2. The optical communication system according to claim 1, wherein the dispersion compensator has a negative dispersion slope for compensating for a dispersion slope of the photonic bandgap optical fiber at the operation wavelength.

3. The optical communication system according to claim 1, wherein the dispersion compensator has a wavelength dispersion of an absolute value equal to or larger than three times of the wavelength dispersion of the photonic bandgap optical fiber.

4. The optical communication system according to claim 1, wherein the dispersion compensator has a wavelength dispersion equal to or smaller than −150 ps/nm/km at the operation wavelength.

5. The optical communication system according to claim 1, wherein the dispersion compensator has a value equal to or smaller than 100 nm as a value obtained by dividing the wavelength dispersion by the dispersion slope at the operation wavelength.

6. The optical communication system according to claim 1, wherein the operation wavelength includes 1550 nm.

7. The optical communication system according to claim 1, wherein the dispersion compensator is a fiber-type dispersion compensator.

8. The optical communication system according to claim 7, wherein the fiber-type dispersion compensator has a cutoff wavelength equal to or shorter than the operation wavelength.

9. The optical communication system according to claim 8, wherein
the fiber-type dispersion compensator includes
a center core region,
an inner core layer that is formed around the center core region and that has a refractive index lower than a refractive index of the center core region,
an outer core layer that is formed around the inner core layer and that has a refractive index lower the refractive index of the center core region and higher than the refractive index of the inner core layer, and
a cladding layer that is formed around the outer core layer and that has a refractive index higher than the refractive index of the inner core layer and lower than the refractive index of the outer core layer, wherein
a relative refractive index difference Al of the center core region with respect to the cladding layer is in a range between 1.6% and 3.0%, inclusive,
a relative refractive index difference Δ2 of the inner core layer with respect to the cladding layer is in a range between −1.6% and −0.2%, inclusive,
a relative refractive index difference Δ3 of the outer core layer with respect to the cladding layer is in a range between 0.1% and 0.7%, inclusive,
a ratio a/c of a diameter of the center core region to an outer diameter of the outer core layer is in a range between 0.05 and 0.4, inclusive,
a ratio b/c of an outer diameter of the inner core layer to the outer diameter of the outer core layer is in a range between 0.4 and 0.85, inclusive, and
an outer radius c of the outer core layer is in a range between 5 μm and 25 μm, inclusive.

10. The optical communication system according to claim 9, wherein the fiber-type dispersion compensator has
the relative refractive index difference Δ1 of the center core region with respect to the cladding layer in a range between 1.9% and 2.7%, inclusive,
an α value that defines a profile of the center core region in a range between 2 and 20, inclusive,
the relative refractive index difference Δ2 of the inner core layer with respect to the cladding layer in a range between −1.62% and −0.6%, inclusive,
the relative refractive index difference Δ3 of the outer core layer with respect to the cladding layer in a range between 0.2% and 0.6%, inclusive,
the ratio a/c of the diameter of the center core region to the outer diameter of the outer core layer in a range between 0.1 and 0.3, inclusive,
the ratio b/c of the outer diameter of the inner core layer to the outer diameter of the outer core layer in a range between 0.5 and 0.75, inclusive, and
the outer radius c of the outer core layer in a range between 10 μm and 20 μm, inclusive.

11. A dispersion-compensating optical fiber configured to be connected closely to a photonic bandgap optical fiber that includes a core that is formed with a hole at a center, a second cladding that is formed on an outer side of the core, and a first cladding that is formed between the core and the second cladding, in which a Bragg grating is formed by periodically arranging a medium having a refractive index that is different from a refractive index of the second cladding, and that propagates a light having a predetermined operation wavelength within a photonic bandgap that is formed by the Bragg grating, the dispersion-compensating optical fiber having a negative wavelength dispersion for compensating for a wavelength dispersion of the photonic bandgap optical fiber at the operation wavelength.

12. The dispersion-compensating optical fiber according to claim 11, having a negative dispersion slope for compensating for a dispersion slope of the photonic bandgap optical fiber at the operation wavelength.

13. The dispersion-compensating optical fiber according to claim 11, having a wavelength dispersion equal to or smaller than −150 ps/nm/km at the operation wavelength.

14. The dispersion-compensating optical fiber according to claim 11, having a value equal to or smaller than 100 nm as a value obtained by dividing the wavelength dispersion by the dispersion slope at the operation wavelength.
